(19) United States
(12) Patent Application Publication
(10) Pub. No.: US 2019/0273602 A1
(43) Pub. Date: Sep. 5, 2019

(54) CHAOTIC PERMUTATION SPREAD SPECTRUM SYSTEM AND METHOD THEREFO

(71) Applicant: BENCHMARK ELECTRONICS, INC., TEMPE, AZ (US)

(72) Inventors: HIEP TRUONG, TEMPE, AZ (US); JIM LUECKE, TEMPE, AZ (US)

(73) Assignee: BENCHMARK ELECTRONICS, INC., TEMPE, AZ (US)

(21) Appl. No.: 16/356,965

(22) Filed: Mar. 18, 2019

Related U.S. Application Data
(60) Provisional application No. 62/617,930, filed on Jan. 16, 2018.

(51) Int. Cl. H04L 9/00; H04B 1/7073; H04L 27/26; H04W 12/00

(52) U.S. Cl. CPC H04L 9/001; H04B 1/7073; H04L 2209/80; H04L 27/265; H04W 12/001; H04L 27/2628

(57) ABSTRACT

A method for forming a chaotic permuted spread spectrum signal comprising: upsampling data from a data signal forming an upsampled data packet; and permuting the upsampled data package.

### RELATED APPLICATIONS

This patent application is related to U.S. Provisional Application No. 62/617,930 filed Jan. 16, 2018, entitled “CHAOTIC PERMUTATION SPREAD SPECTRUM (C)-PSS” in the name of Hiep Truong and Jim Luecke, and which is incorporated herein by reference in its entirety. The present patent application claims the benefit under 35 U.S.C § 119(e).

### TECHNICAL FIELD

The present application relates generally to the technical field of wireless networks, and more specifically, to the technical field of Commercial off-the-shelf (COTS) wireless networks using chaotic permutation spread spectrum to improve security by lowering the probability of intercept and probability of detection, improving interference and jamming resistance, and improving multipath resistance.

### BACKGROUND

Commercial off-the-shelf (COTS) products are ready-made merchandise that is available for sale. The term may be applied to any hardware or packaged software that is readily available to the general public. This is in contrast to customers that may commission products that may be custom built to specific user requirements.

Unfortunately, custom built products may not always meet the needs of customers. The high cost and lengthy development cycle of custom-built products runs counter to many customer's desire for quick and low-cost solutions. In general, COTS products can be obtained and operated at a lower cost over a custom build.

While COTS products may offer certain advantages over custom builds, they also have one major drawback. One of the most concerning issues of using a COTS product is security. While some COTS communication products may offer some type of spread spectrum technology to provide secure communication, they may still be vulnerable to unauthorized access. While encryption of data may be used to ensure secure data transmission, to add encryption is expensive in both development and production. Further, since encryption may require a hardware implementation, it can also significantly impact the power consumption of the device/system.

Therefore, it would be desirable to provide a system and method that overcomes the above.

### SUMMARY

In accordance with one embodiment, a method for forming a chaotic permuted spread spectrum signal is disclosed. The method comprises: upsampling data from a data signal forming an upsampled data packet; and permuting the upsampled data package.

In accordance with one embodiment, a method for forming a chaotic permuted spread spectrum signal is disclosed. The method comprises: performing an initial permutation on data from a data signal forming a permuted data packet; upsampling the permutated data packet forming a plurality of permuted data packets; and permuting each of the permuted data packets.

In accordance with one embodiment, a method for forming a chaotic permuted spread spectrum signal is disclosed. The method comprises: receiving a data signal; performing an initial permutation on data from the data signal forming a permuted data packet; upsampling the permutated data packet forming a plurality of permuted data packets; permuting each of the permuted data packets; and combining each of the permuted data packets forming an encrypted spread-spectrum sequence.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is an exemplary block diagram depicting a wireless transmitter and receiver in accordance with one aspect of the present application;

FIG. 2 is a simplified block diagram showing permutation of input data in accordance with one aspect of the present application;

FIG. 3 is a simplified block diagram showing a Substitute-Permutation Network (SPN) in accordance with one aspect of the present application;

FIG. 4 is an exemplary block diagram of a processing block of FIG. which combines encryption and spread-spectrum in accordance with one aspect of the present application;

FIG. 5 is an exemplary block diagram showing operation of the processing block of FIG. 1 in accordance with one aspect of the present application;

FIG. 6 is an exemplary waveform formed and transmitted in accordance with one aspect of the present application;

FIG. 7 is an exemplary block diagram showing demodulation of the exemplary waveform formed and transmitted in accordance with one aspect of the present application; and

FIG. 8 is an exemplary block diagram showing low data rate operation in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Due to the cost and time savings, COTS wireless standards are desirable in many applications. However, many COTS components have been developed without a focus on robustness and security. The present disclosure provides a module for COTS wireless systems in order to: 1) improved LPI/LPD (low probability of intercept and low probability of detection); 2) improved interference and jamming resistance (AJ), 3) improved multipath resistance; and 4) improved physical layer security all while maintaining the core PHY and MAC layers. The above is accomplished through the addition of a hardware element that combines encryption and spread-spectrum into a single element. The hardware element offers the above advantages with minimal impact to radio architecture. The above can be easily bypassed to enable legacy operation.

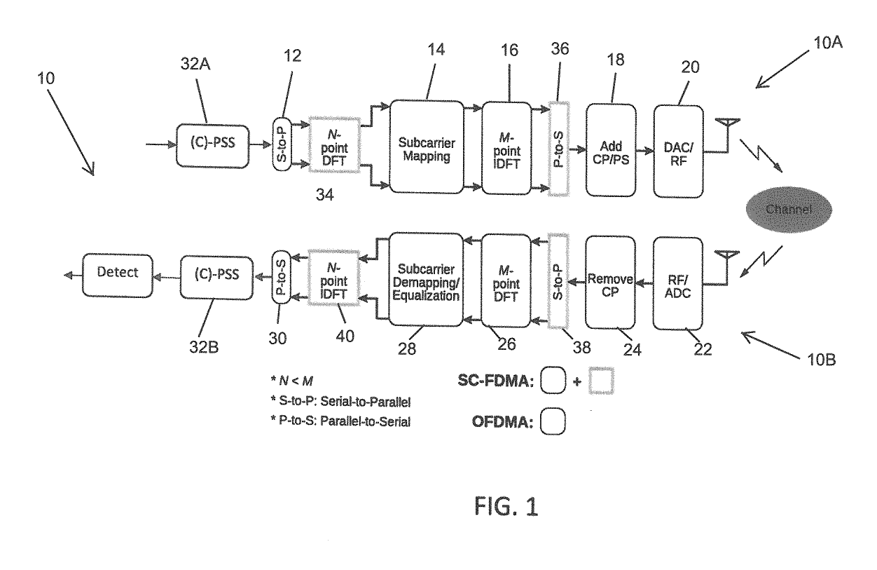

Referring to FIG. 1, a wireless communication device 10 (hereinafter device 10) in accordance with one embodiment of the present application may be seen. In accordance with one embodiment, the device 10 may be Inverse Discrete Fourier transform/Discrete Fourier Transform IDFT/DFT based devices using WiFi, LTE, WiMax, or similar wireless technology. The communication device 10 may use a single processing module located prior to the Inverse Discrete Fourier Transform (IDFT) on the transmission side and after the Discrete Fourier Transform (DFT) on the receiving side of the device 10. The device 10 may be described below using Orthogonal Frequency-Division Multiplexing (OFDM) as a method of encoding digital data on multiple carrier frequencies and Single-carrier Frequency Division Multiple Access (SC-FDMA) as a method of assigning multiple users to a shared communication resource. However, other modulation methods may be used.

As may be seen in FIG. 1, the device 10 may have a transmitting side 10A and a receiving side 10B sending and receiving data on one or more channels. When using ODFM, on the transmitting side 10A, an incoming signal may be sent to a serial to parallel converter 12. The serial to parallel converter may take the input data with a single subcarrier and convert it to a large number of closely spaced orthogonal subcarriers that are transmitted in parallel. The different subcarriers are mapped via subcarrier mapping 14. The signal may be sent to a modulator 16 where modulation of the signal may be performed. In the present embodiment, Inverse Discrete Fourier Transform (IDFT) may be used. However, other algorithms such as Inverse Fast Fourier Transform (IFFT) and similar methods may be used.

The modulated signa from the modulator 16 may be sent to CP/RS 18 where a cyclic prefix is added and the modulated signal filtered for transmission. The cyclic prefix acts as a buffer region or guard interval to protect the modulated signal from intersymbol interference. By filtering the modulated signal, the intersymbol interference caused by the channel can be kept in control. The modulated signal may then be sent to a Digital-To-Analog Converter/Radio Frequency DAC/RF transmitter 20 for transmission.

On the receiving side 10B, the signal may be received by a Radio Frequency/Analog-To-Digital Converter receiver 22. The received signal may have the cyclic prefix removed in CP module 24. The received signal may be sent to a demodulator 26 where the received signal may be demodulated. In the present embodiment, Discrete Fourier Transform (DFT) may be used. However, other algorithms such as Fast Fourier Transform (FFT) and similar methods may be used. Subcarrier demapping may be performed in module 28 to extract data mapped on the assigned subcarriers and then sent to a parallel to serial converter 30.

A processing block 32A may be positioned prior to the modulator 16 on the transmitting side 10. A processing block 32B may be positioned after the demodulator 26 on the receiving side 10B. The processing blocks 32A combines encryption and spread-spectrum into a single element, while processing block 32B reverses the process in order to: 1) improved LPI/LPD (low probability of intercept and low probability of detection); 2) improved interference and jamming resistance (AJ), 3) improved multipath resistance; and 4) improved physical layer security all while maintaining the core PHY and MAC layers. The above may be accomplished with purely data manipulation with minimal signal processing.

The device 10 may be extend to use Single-carrier Frequency Division Multiple Access (SC-FDMA) as a method of assigning multiple users to a shared communication resource. In this embodiment, on the transmitting side 10A, an n-point DFT module 34 may be positioned prior to the subcarrier mapping 14 and a parallel to serial converter 36 may be positioned after the modulator 16. On the receiving side, a serial to parallel converter 38 may be positioned before the demodulator 26 and an n-point IDFT module 40 may be positioned after the subcarrier demapping module 28.

Spread spectrum and direct sequence spread spectrum are modulation techniques to reduce signal interference. The spreading of this signal makes the resulting wideband channel more noisy, allowing for greater resistance to unintentional and intentional interference. Thus, the greater the signal looks like noise, the harder it may be for one to detect, jam or disrupt the signal.

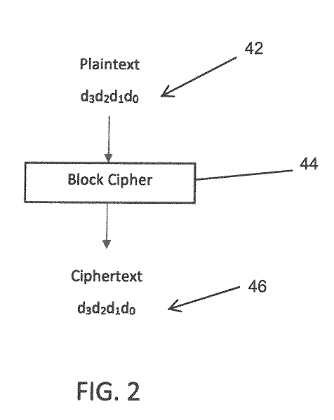

In cryptography, permutation is a method of bit shuffling. The objective of permutation is to randomize plaintext data positions within a specific block. Referring to FIG. 2, plain text data 42 is run through a block cipher 44. The block cipher 44 applies an algorithm so that the position of the plaintext data is randomly positioned as ciphertext 46. As may be seen in the embodiment shown in FIG. 2, the plain text data 42 may be 4-bit data comprising d₃d₂d₁d₀. The block cipher 44 applies an algorithm so that the position of the plaintext data 42 is randomly positioned as cipher text 45 d₀d₂d₃d₁. The above is given as an example as the block cipher 44 may place the 4-bit data into other orders. Multiple blocks of data could be collected to enable an N×N permutation matrix.

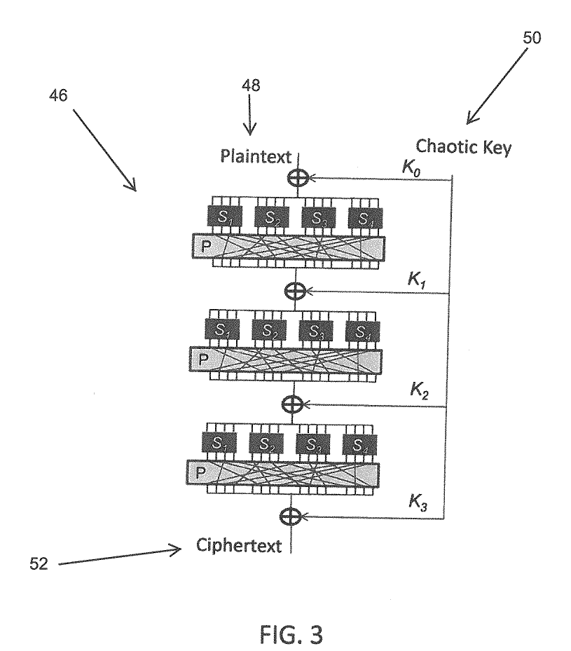

Substitute-Permutation Network (SPN) is another cryptography technique. Referring to FIG. 3, a SPN 46 may be seen. The SPN 46 may take a block of plaintext 48 and a key 50 as inputs and applies multiple “rounds” of substitution boxes S₁-S₄ and permutation boxes P to produce ciphertext 52. In each “round” a different key K₀-K₃ may be introduced. The embodiment shown in FIG. 3 shows three (3) “rounds”. This is only shown as an example as fewer or more “rounds” may be done.

Each substitution box S₁-S₄ substitutes a small block of bits (the input of the S-box) by another block of bits (the output of the S-box). This substitution should be one-to-one, to ensure invertibility (hence decryption). In particular, the length of the output should be the same as the length of the input (i.e., S-boxes with 4 input will have 4 output bits).

Each permutation box P is a permutation of all the input bits. In other words, each permutation box P may take the outputs of all the S-boxes of one round, permutes the bits, and feeds them into the S-boxes of the next round.

Decryption of the cipher text may be done by reverse substitution/permutation process.

Advanced Encryption Standard (AES) is a standard for the encryption of electronic data established by the US National Institute of Standards and Technology (NIST). AES is a symmetric-key algorithm, meaning the same key may be used for both encrypting and decrypting the data. AES is a substitution/permutation encryption algorithm that does not use chaotic sequences.

AES is a block cipher. It works over 128-bit blocks. For a given key, AES is a permutation of 2¹²⁸ possible values that 128-bit blocks may assume. As a purportedly secure block cipher, AES is supposed to be indistinguishable from a random permutation. Statistical tests prove the process is computationally indistinguishable from a true random source. Results showed that after the 3^{rd} round (and all subsequent rounds) the statistics show AES/Rijndael to be random. This opens up the possibility of using the AES not only for LPI but also as an LPD and AJ mechanism. With chaotic sequences this fundamental approach should be even better.

The processing blocks 32A (FIG. 1) combines encryption and spread-spectrum into a single element. In general, spreading gain may be achieved in spread-spectrum systems through redundancy. Typically, a data stream at rate Rb is spread to higher rate Rc. Rc expands the system bandwidth and in so doing effective places this data across the entire bandwidth. With the data so spread an interferer, whether intentional or not, must wipe out a significant portion of the bandwidth to make it impossible to recover the original data. In general, the data is first encrypted and then spread using a second process.

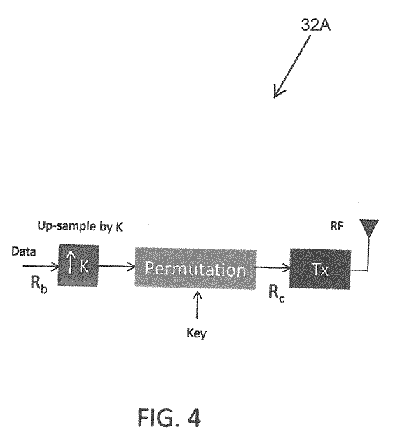

Referring to FIG. 4, the processing blocks 32A combines encryption and spread-spectrum into a single element. The process may be combined by first upsampling the data R_{b}, which is simply to repeat the data to an appropriate system bandwidth. The system bandwidth may be the bandwidth of the transmitted signal expanded by a factor K. Permutation techniques may be used on the up-sampled data to generate an encrypted, spread spectrum data stream R_{c}. During the permutation process, a key may be introduced.

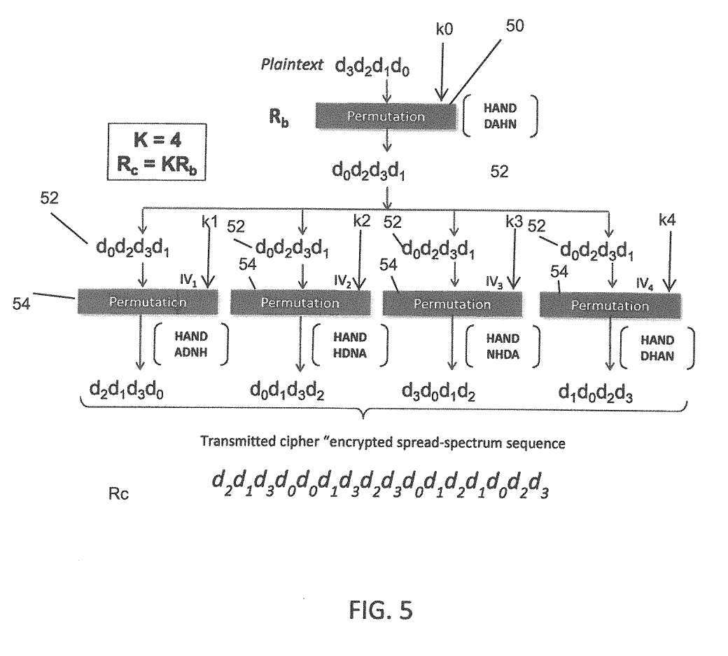

Referring to FIG. 5, a simplified diagram showing operation of the processing blocks 32A for a permutated spread spectrum process may be seen. A data signal R_{b} may be send to a permutation block 50. The permutation block 50 permutes the plaintext of the data signal R_{b} so that the position of each bit of the plaintext data is randomly positioned. In the embodiment shown, the permutation block 50 permutes the 4-bit input data signal R_{b} from d₃d₂d₁d₀ to d₀d₂d₃d₁. The above is given as an example. The permutation block 50 may permute the 4-bit input data signal R_{b} into different orders than that shown.

The permutated data may then be upsampled and the bandwidth may be expanded by a factor K. In the present embodiment, the bandwidth of the data signal R_{b} is expanded by a factor of K=4. Expanding the bandwidth by a factor of 4 provides anti-jam capabilities. Thus, the permuted data 52 gets unsampled (i.e., replicated by the factor K). In the present embodiment, the permuted data 52 may be replicated to form four (4) sets of permuted data 52₁-52₄. Each of the sets of permuted data 52₁-52₄ may be sent to a corresponding independent permutation block 54₁-54₄. A key k₀-k₅ may be introduced at each permutation block 50 and 54₁-54₄. Each independent permutation block 54₁-54₄ performs a permutation of the corresponding permuted data 52₁-52₄ the output of which is combined to forms a data signal R_{C} which is an encrypted spread-spectrum sequence. Thus, an initial 4-bit data signal R_{b} having plaintext of d₃d₂d₁d₀ may be transmitted as a 16-bit data signal R_{C}. While the present embodiment shows the 16-bit data signal R_{C} as d₂d1d₃d₀d₀d₁d₂d₃d₀d₁d₂d₁d₀d₂d₃ this is shown as an example and should not be seen in a limiting manner.

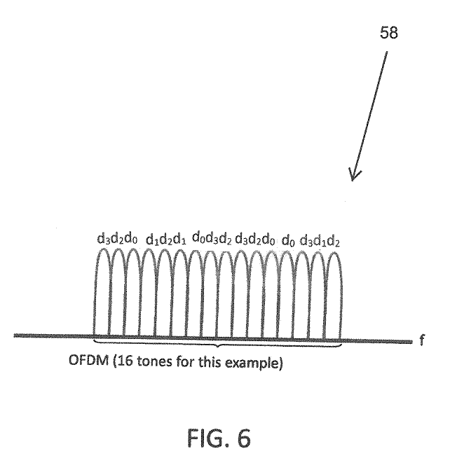

Referring to FIGS. 1, 5 and 6, orthogonal Frequency-Division Multiplexing (OFDM) is a method of encoding digital data on multiple carrier frequencies. In the above example, the initial 4-bit data signal R_{b} having plaintext of d₃d₂d₁d₀ goes through the encryption spread-spectrum sequence forming the 16-bit data signal R_{C} d₂d1d₃d₀d₀d₁d₃d₂d₃d₀d₁d₂d₁d₀d₂d₃ like in FIG. 5. The data signal R_{C} may go through the serial to parallel converter 12. The output of the serial to parallel converter 12 may be a parallel block of data may be sent to the modulator 16 where modulation of the signal may be performed using Inverse Fast Fourier Transform (IFFT) to form the signal 58 as shown in FIG. 6. The signal 58 may be transmitted as an encrypted spread-spectrum sequence. As one can see, the original data signal R_{b} may be repeated and interleaved across the entire frequency band with each bit replicated in multiple tones.

Permutation-based encryption on up-sampled sequence offers better protection than low rate encryption. The present embodiment as shown provides longer and more complex permutation sequence. The input data is repeated and then interleaved across the entire frequency band. This provides inherent robustness against narrowband jamming and interference and improved performance against multipath. Data interleaving provides gain against frequency selective fading. As the rate is reduced by K, either transmit power can be reduced (LPD) or range extended.

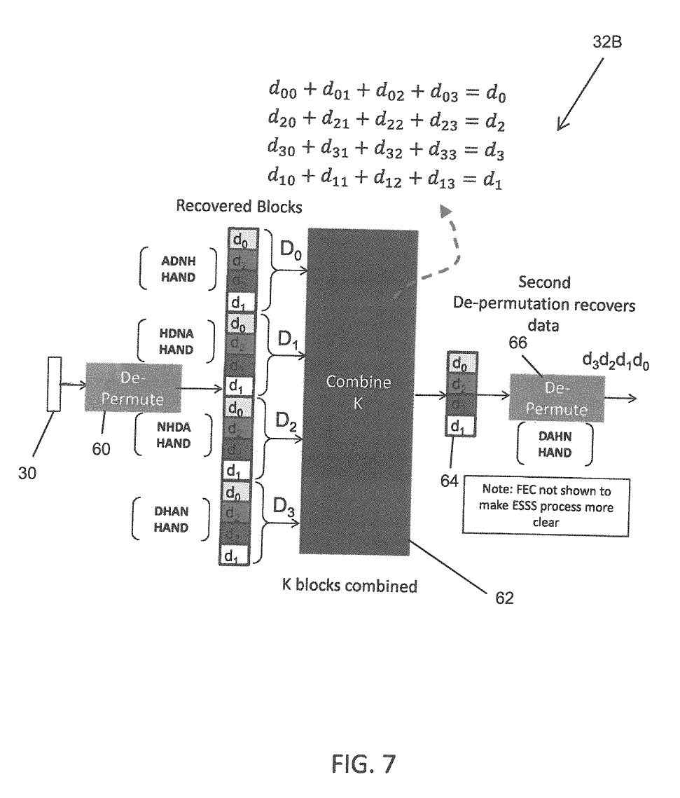

Referring to FIGS. 1 and 7, demodulation of the transmitted signal data signal may be disclosed. The transmitted signal received by the receiving side 10B of the wireless device 10 may be designated as received signal Rₓ. The received signal Rₓ will go through the different components of the receiving side 10B. The output of the parallel to serial converter 30 may be sent to a first depermutation block 60. The first depermutation block 60 separates the received signal Rₓ into K factor number of blocks D. In the present embodiment, first depermutation block 60 separates the received signal Rₓ into four blocks D₀D₁D₂D₃. The K factor number of blocks D may then be combined in module 62. The K factor number of blocks D may be combined so that corresponding bites of each block D are combined to form a combined data block 64. Thus, in the present embodiment, the first bit of all K factor number of blocks D are combined, the second bit of all K factor number of blocks D are combined, the third bit of all K factor number of blocks D are combined, and the fourth bit of all K factor number of blocks D are combined to form combined the combined data block. The combined data block 64 may then go through a second depermutation block 66 to recover the original unencrypted non-spread data.

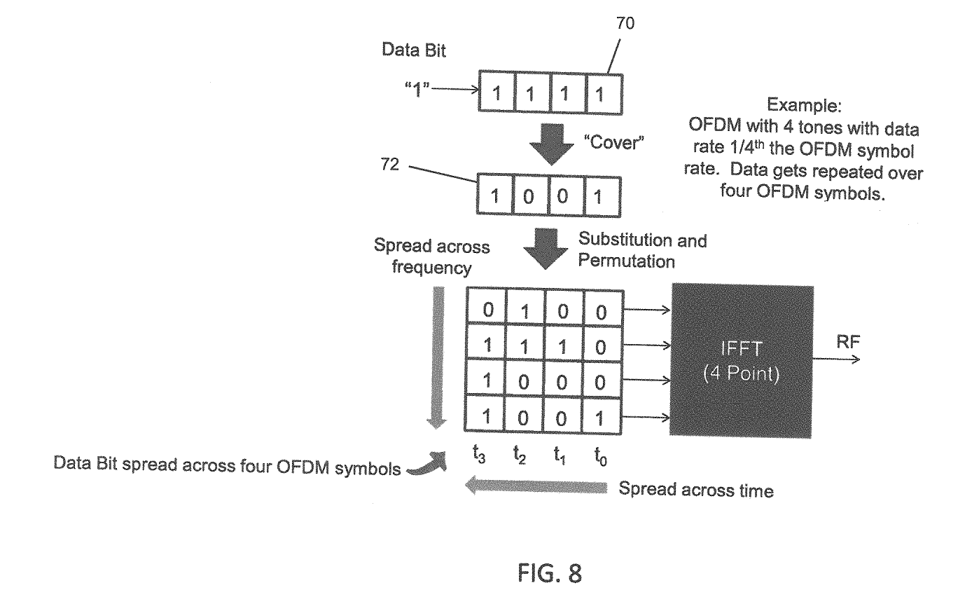

Referring to FIG. 8, low data rate operation may be disclosed. For practical operation, spreading occurs in both time and frequency domain when data rate is less than the modulation symbol rate. In the embodiment shown in FIG. 8, OFDM with 4 tones with data rate ¼^{th} the OFDM symbol rate may be seen. The data gets repeated over four OFDM symbols to form a block 70 of data. The block 70 of data may go through a “cover” process wherein certain bits are manipulated and changed to form a “cover” block of data 72. The “cover” block of data may then go through the permutation process disclosed above. Thus, in the present embodiment, a single data bit is encrypted into a 16-symbol sequence transmitted over four consecutive OFDM symbols. Spreading gain of 16 providing more secure encryption—16 cipher symbols for every bit.

In substitution/permutation network of present invention, synchronization may be effectively the same as found in spread-spectrum systems. The given state of the substitution/permutation network is established based upon Time and the Key. On the receiver side, when Time is properly aligned, do-permutation results. Time alignment ‘dispreads’ the signal enabling detection. This detection can be performed through signal identification (e.g. header on the PHY) or detection of correct decoded data sequence. Multiple search techniques can be employed. For example, a simple sequential search may be employed. Signal aids, such as preambles or frame markers, could be added to the signal to speed acquisition. Synchronization would be coordinated with the radio legacy acquisition process. It should be noted that the approach outlined above does not necessitate continuous transmission. Burst and other operations could be supported.

The foregoing description is illustrative of particular embodiments of the application, but is not meant to be a limitation upon the practice thereof. The following claims, including all equivalents thereof are intended to define the scope of the application.

What is claimed is:

1. A method for forming a chaotic permuted spread spectrum signal comprising:
upsampling data from a data signal forming an upsampled data packet; and
permuting the upsampled data package.

2. The method of claim 1, comprising performing an initial permutation on the data from the data signal prior to upsampling the data.

3. The method of claim 1, wherein upsampling comprises replicating the data of the data signal by a factor of K wherein K is greater than 1.

4. The method of claim 3, wherein the factor of K is at least 3.

5. The method of claim 1, wherein upsampling comprises replicating the data of the data stream to form a plurality of upsampled data packets, wherein a number of upsampled data packets is equal to a factor K wherein K is 3 or more.

6. The method of claim 3, wherein permuting the upsampled packet comprises permuting each factor of K of the data.

7. The method of claim 7, comprising combining each factor of K of the data which has been permuted.

8. The method of claim 5, wherein permuting the upsampled packet comprises permuting each of the plurality of upsampled data packets.

9. The method of claim 8, comprising combining each of the plurality of upsampled data packets which have been permuted.

10. A method for forming a chaotic permuted spread spectrum signal comprising:
performing an initial permutation on data from a data signal forming a permuted data packet;
upsampling the permutated data packet forming a plurality of permuted data packets; and
permuting each of the permuted data packets.

12. The method of claim 10, wherein upsampling comprises replicating the permuted data packet by a factor of K wherein K is 3 or more.

13. The method of claim 10, comprising combining each of the permuted data packets forming an encrypted spread-spectrum sequence.

14. A method for forming a chaotic permuted spread spectrum signal comprising:
receiving a data signal;
performing an initial permutation on data from the data signal forming a permuted data packet;
upsampling the permutated data packet forming a plurality of permuted data packets;
permuting each of the permuted data packets; and
combining each of the permuted data packets forming an encrypted spread-spectrum sequence.

15. The method of claim 14, wherein upsampling comprises replicating the permuted data packet by a factor of K wherein K is 3 or more.

16. A method of wireless communication of a chaotic permuted spread spectrum signal comprising:
receiving a data signal;
performing an initial permutation on data from the data signal forming a permuted data packet;
upsampling the permutated data packet by a factor of K to form a plurality of permuted data packets, wherein the plurality of permuted data packets is equal to K;
permuting each of the permuted data packets;
combining each of the permuted data packets forming an encrypted spread-spectrum sequence signal; and
transmitting the encrypted spread-spectrum sequence signal.

17. The method of claim 16, comprising:
receiving the encrypted spread-spectrum sequence signal; and
decrypting the encrypted spread-spectrum sequence signal.

18. The method of claim 17, wherein decrypting the encrypted spread-spectrum sequence signal comprises:
parallel-to-serial converting of the encrypted spread-spectrum sequence signal forming a serial data stream;
depermuting the serial data stream forming a plurality of depermuted data blocks the plurality of depermuted data blocks equal to K;
combining the depermuted data blocks forming a combined data block; and
depermuting the combined data block.

19. The method of claim 17, wherein K is equal to 3 or more.
